(19) United States
(12) Patent Application Publication
(10) Pub. No.: US 2013/0136285 A1
(43) Pub. Date: May 30, 2013

(54) INFLATABLE EAR PIECE WITH PRESSURE RELIEF VALVE

(71) Applicant: Frank Naumann, Erlangen (DE)

(72) Inventor: Frank Naumann, Erlangen (DE)

(73) Assignee: SIEMENS MEDICAL INSTRUMENTS PTE. LTD., SINGAPORE (SG)

(21) Appl. No.: 13/702,663

(22) PCT Filed: Oct. 28, 2010
(86) PCT No.: PCT/EP2010/066390

§ 371 Date: Dec. 7, 2012

Related U.S. Application Data
(60) Provisional application No. 61/363,814, filed on Jul. 13, 2010.

(51) Int. Cl. H04R 25/00

(52) U.S. Cl. CPC H04R 25/608
USPC 381/329

(57) ABSTRACT

An ear piece is formed for insertion and placement in an external auditory canal, preferably for deep insertion and in close vicinity of a tympanic membrane inwardly bounding the auditory canal. The ear piece has an inflatable balloon which, when it is inflated, expands and braces against the walls of the auditory canal. When it is deflated, it may be withdrawn from the auditory canal. The ear piece has a receiver module with a sound generator and a connection to an exterior device (e.g., a hearing aid, an MP3 player, a cell phone). The receiver module is integrally formed with a pressure relief valve that allows the balloon to be deflated by external activation. A pull cord pulls a valve piston off a valve seat, whereupon the pressure in the balloon is relieved and the ear piece may be pulled out of the auditory canal.

### BACKGROUND OF THE INVENTION

### Field of the Invention

The invention relates to an ear piece for a hearing device, in particular, an inflatable ear piece or an ear piece with an inflatable balloon. The ear piece is particularly suitable for delivering sound from a hearing aid or an audio player.

Along with the ever-increasing miniaturization of electronic devices and the increasing prevalence of audiological devices that require direct delivery of sound to the human ear, there is a desire to provide ever smaller devices that may be placed in the auditory canal of a user.

For example, hearing devices are wearable hearing apparatuses which are used to supply the hard-of-hearing. A variety of different configurations of hearing devices are known, such as, for example, behind-the-ear hearing devices (BTE), hearing device with an external receiver (RIC: receiver in the canal) and in-the-ear hearing devices (ITE), e.g. also concha hearing devices or canal hearing devices (ITE—in-the-ear, CIC—completely in the canal). Similarly, headphones for the personal delivery of auditory materials have recently become more miniaturized and they have progressed to very small earbuds with in the canal speakers.

U.S. Pat. No. 7,227,968 B2 describes a two-part hearing aid in which the receiver, which is separate from the remaining components, may be inserted deep into the auditory canal. The receiver houses a speaker, which is driven by way of an electrical connection through the canal. The receiver housing is surrounded by an inflatable soft shell, which, when inflated and thus expanded, fixes the receiver in position in the auditory canal.

Similarly, U.S. Pat. No. 7,425,196 B2 also describes a receiver module for a hearing aid that may be positioned deep in the auditory canal. The receiver housing is surrounded by an expandable material, which may be expanded against the walls of the canal.

### BRIEF SUMMARY OF THE INVENTION

It is an object of the invention to provide an inflatable ear piece, which overcomes several disadvantages of the heretofore-known devices and methods of this general type and which provides for a device that may be inflated for safe placement in the ear canal and that may be deflated and removed from the ear canal with little effort. In addition, it is desirable for the device to be protected against earwax (i.e., cerumen) and moisture, yet be simple and inexpensive to produce.

With the foregoing and other objects in view there is provided, in accordance with the invention, an ear piece for a hearing device which comprises:
a receiver module housing a control unit for generating audible sound to be delivered to the tympanic membrane;
an inflatable balloon attached to the receiver module, the inflatable balloon having a shape and a size to brace against the walls of the auditory canal upon being inflated and to allow easy removal of the ear piece from the auditory canal when the balloon is deflated; and
a pressure relief valve pneumatically connected to an interior of the balloon and selectively activatable for deflating the balloon.

In a preferred embodiment of the invention, the pressure relief valve is integrally formed together with the receiver module.

In another advantageous embodiment of the invention, the pressure relief valve includes a piston and a spring means (e.g., a helical spring) biasing the piston against a valve seat for closing a pneumatic connection from an interior of the balloon to an exterior. The pressure relief valve may include a pull string connected to the piston for pulling the piston backward against a spring force of the spring means and for relieving a pressure in and deflating the balloon.

In one preferred embodiment of the invention, the ear piece has a size and a shape enabling deep insertion into an external auditory canal and in close vicinity of a tympanic membrane (i.e., the ear drum) inwardly bounding the auditory canal.

The ear piece is particularly suitable for connection to an external device (e.g., hearing aid, sound player, cell phone, etc.) providing signals for the control unit.

In accordance with a preferred embodiment, the signal connection includes an electrical cable carrying electrical control signals and an energy supply. The drive signals or control signals, as well as the energy supply, may be carried in the electric cable connected through the ear canal. The cable and the pull cord may be combined to form a tether for the removal of the deep-insertion ear piece.

Also, there may be provided a tube pneumatically connecting the balloon with an exterior pump for selectively inflating the balloon. In the alternative, there may be provided a pump in the receiver module for selectively inflating the balloon, and a pneumatic connection enabling aspiration of air through the auditory canal for inflation of the balloon.

In a modular configuration of the ear piece, there may be provided a carrier member which, for mounting to the receiver module may be snapped in place on an extension of the receiver module, and which is sealed with the balloon. Preferably, the carrier member is funnel-shaped with a central bore for guiding sound waves generated by the control unit in the receiver module through a forward wall of the ear piece and to the tympanic membrane.

As noted, the inflatable ear piece may be combined with any of a plurality of audiological devices, such as a hearing aid, an MP3 player, a cell phone, or any other such electronic device.

In the case of a hearing aid implementation of the invention, the microphone, the amplifier, the control unit, and the power supply is disposed in an external unit, such as a BTE (behind-the-ear) unit or an ITE (in-the-ear) unit, or in a CIC or concha device. The inflation pump may be disposed in the deep-insertion ear piece itself or in the external or partly inserted unit. The inflatable (deep-insertion) ear piece is electrically connected to the other unit by way of an electrical control cable and, in one case, also through a pneumatic hose.

The placement and fixation of the respective devices by way of otoplastic materials need not be described in further detail. Those of skill in the art of hearing devices are quite familiar with the pertinent technology and are able to configure the respective system according to the specific requirements.

In sum, the basic concept is to have an inflatable balloon in the ear to seal the inner part of the ear canal against the environment and also to enable the deep-insertion unit to be safely held in place. To realize a comfortable wearing position, the balloon is inflated. When there is too much pressure in the balloon, or if the ear piece should be removed, it is necessary to deflate the balloon. Also, when it is desirable to reinsert the ear piece, it is necessary to completely empty the balloon before the next insertion. The novel invention enables these functions with a simple structure and it makes it easily operable by the audiologist, but also by the wearer.

Other features which are considered as characteristic for the invention are set forth in the appended claims.

Although the invention is illustrated and described herein as embodied in an inflatable ear piece to be inserted into an auditory canal, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 is a schematic view of an outer ear and an auditory canal leading to an ear drum;

FIG. 2 is a similar view illustrating a deep-insertion ear piece placed inside the auditory canal;

FIG. 3 is a longitudinal section taken through a deep-insertion ear piece according to the invention;

FIG. 4 is a perspective view thereof; and

FIG. 5 is a longitudinal section taken through the receiver module and a pressure relief valve according to the invention.

### DETAILED DESCRIPTION OF THE INVENTION

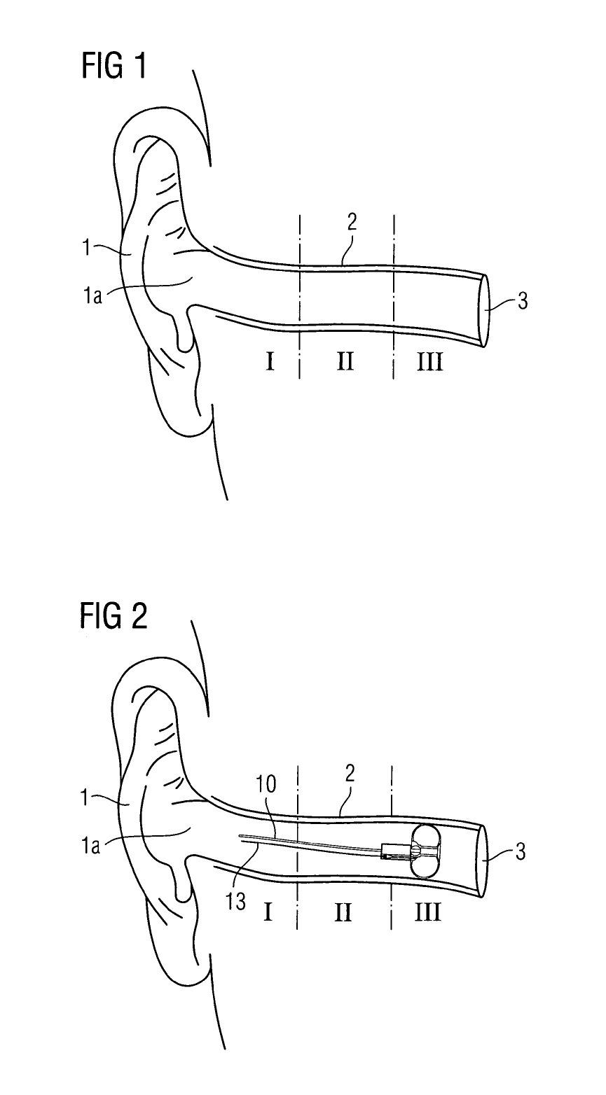

Referring now to the figures of the drawing in detail and first, particularly, to FIG. 1 thereof, there is seen a human ear 1 and an external auditory canal 2. The auditory canal is bounded by a tympanic membrane 3, also referred to as the eardrum. In unassisted hearing, pressure waves (sound waves are longitudinal waves with changes in pressure) are funneled at the concha 1a of the ear 1, they travel through the external auditory canal 2, also referred to as the ear canal or, simply canal, before they impinge on the tympanic membrane 3.

In assisted hearing, such as with hearing aids, the propagation of the sound waves through the auditory canal 2 is interrupted. The sound waves are instead picked up by a microphone or the like, the resulting signal is processed, typically by way of digital signal processing, and the processed signal is utilized to excite an oscillator in the vicinity or at the tympanic membrane 3. In the case of ear buds for music or telephony, the sound waves are directly injected at the concha 1a for delivery through the auditory canal 2.

The external auditory canal 2 is divided in FIG. 1 into three regions or sections of approximately equal length. A first region I includes the concha 1a and an outer insertion region which would typically receive a CIC device. A second region II approximately covers the mid-section of the canal 2. Finally, a third region III is the bounded cavity in which a sound generation earpiece according to one embodiment of the instant invention may be placed. As illustrated in FIG. 2, the ear piece is inserted into the third region III. The following references to a “deep” insertion, therefore, will pertain to the insertion of a device primarily into region III, and also into region II.

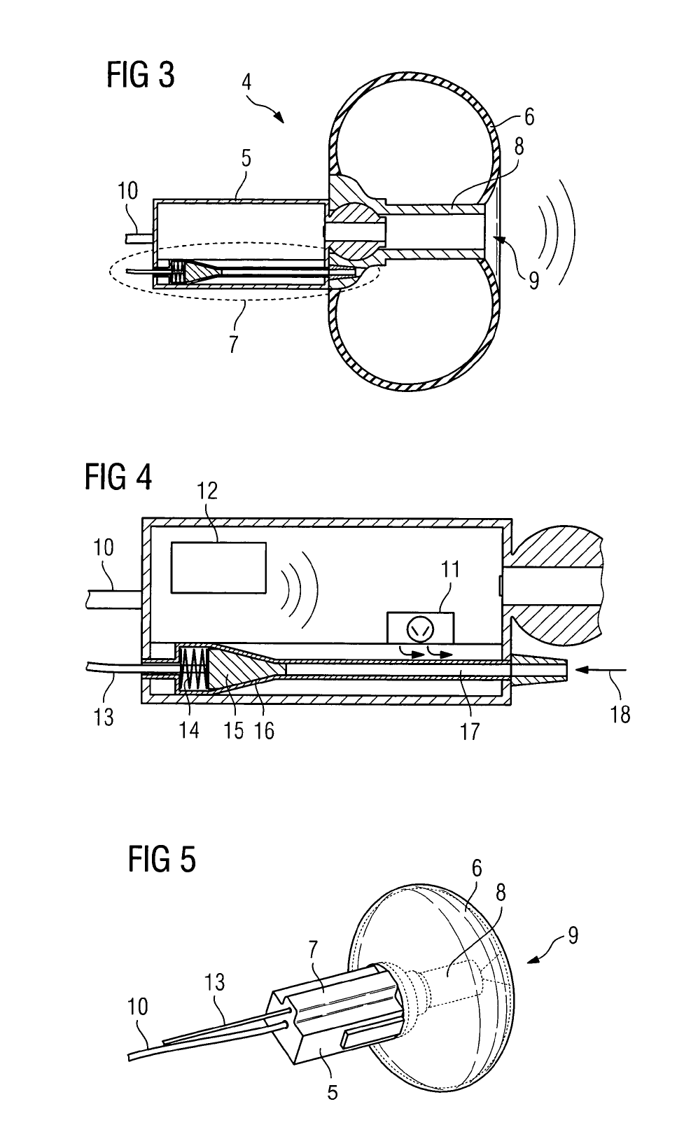

Referring now to FIG. 3, there is seen a deep-insertion ear piece 4 with a receiver module 5, an inflatable member 6, and a pressure relief valve 7. The inflatable member 6, which may be in the form of a balloon or a bag or an accordion-type bellows, and which will be referred to herein as a balloon 6, is fixedly mounted to the receiver module 5 by way of a carrier member 8. The balloon 6 is sealed against the carrier member 8 and the latter is formed so as to be snapped onto the receiver module 5 during manufacture or even for replacement of a worn or defective balloon after first use. The receiver module 5 in the illustrated embodiment is formed with a spherical nose extension, or a ball joint click, onto which the funnel opening of the carrier member 8 may be snapped. In the alternative, it is also possible to provide a bayonet lock, or a similar closure. The ear piece 4 is formed so that it can be inserted into the auditory canal 2, approximately within region III or at the transition from region II to region III. Once placed properly, the balloon 6 is inflated, whereupon it expands and braces itself against the walls of the auditory canal 2.

Referring now to FIG. 4, the carrier member 8 is shaped in the form of a funnel. The funnel is snapped onto a spherical nose extension integrally formed on the receiver module 5. Audible sound that is generated in the receiver module 5 projects through the carrier member 8 and impinges on the tympanic membrane 3. As illustrated, the balloon 6 does not cover a forward opening 9 of the carrier member 8. Instead, the balloon 6 is instead sealed at the forward cylindrical edge of the carrier member 8. It is also possible to stretch the balloon 6 across the opening 9 and to allow the sound waves generated in the receiver module 5 to traverse the forward balloon wall. The completely open forward opening 9 may be advantageous in terms of the sound quality which can be delivered to the ear drum. When the opening 9 is sealed, on the other hand, the system is also sealed against cerumen (ear wax) and water.

The receiver module 5 receives its control signals and also its power supply through a cable 10. The cable 10 is connected, for example, to a hearing aid, such as a behind-the-ear (BTE) hearing aid, a completely-in-the-canal (CIC) unit, or a concha unit. It may also be connected to any other signal source, such as an MP3 player, a cell phone, or the like, or a combination thereof. The signals received through the cable 10 are used in a control unit 12 to generate audible sound for delivery through the carrier element 8 and through the opening 9 to the ear drum 3. The control unit 12 may, therefore, also be referred to as a sound generator.

The balloon 6 may be inflated from an external source or the receiver unit 5 may have a pump 11 integrated therein. The external device may, in that case, have a control possibility that allows the user (or, say, the audiologist) to inflate the device. The pump 11 is diagrammatically indicated inside the module 5 in FIG. 4.

The inflatable ear piece, as noted above, has a pressure release valve 7 to facilitate handling during removal from the ear. To remove the inflatable ear piece, a pull cord 13 is pulled and the pressure release valve opens, letting the inflated part deflate and thus allowing easy removal from the ear.

Referring now to FIG. 5, the cross section shows the receiver module 5 at a slightly larger scale. It is seen that the pull cord 13 satisfies two roles, namely, to pull the deep-insertion ear piece 4 out of the ear canal 2, and also to enable deflation of the balloon 6. As the pull cord 13 is pulled (towards the left in the figures), a spring force of a helical spring 14 is counteracted, and a piston 15 is lifted from its valve seat 16. Once the piston 15 is released, the pressure in the balloon is relieved and the air is allowed to flow out through a pipe 17. The pressure forcing the air through the pipe 17 is indicated by a vector arrow 18.

The pull cord could also be combined with a pull-out string of the otoplastic. Indeed, it would also be possible to combine the pull cord with the signal cable 10. It is only necessary to overcome a closing force (here, the spring force of the spring 14) so as to enable the deflation tube 17 to open. Once the balloon 6 is sufficiently deflated, the ear piece may be easily removed from the auditory canal.

The balloon 6 of the illustrated embodiment is placed forward of the receiver module and the receiver module 5 is retained in a substantially central position between the walls of the ear canal. The centering of the receiver module 5 assures that the module 5 does not bang against the walls of the canal 2 upon considerable shock impulses. It will be understood, however, that the entire receiver module 5 may be encased by the balloon 6.

In a further embodiment of the invention, the hearing device may be an CIC hearing aid with the external unit and the ear piece 4 combined and integrally formed as an insertion unit. The inflatable member 6, in that embodiment, is suitable for fixing the CIC hearing aid in place and to thus reduce the effort in fitting the otoplastic with high accuracy to the patient's ear canal.

The term “balloon” as used herein should be understood in its broadest sense as an inflatable member. It may be in the form of a balloon with resiliently stretchable material, or a bag, or an accordion-type bellows with folded/crimped balloon shapes. Further the material is chosen such that it provides a pleasant haptic feel as it is pressed against the wall of the ear canal 2 and, once inflated, does not shift relative to the canal 2. The balloon 6 is formed of a flexible material which is impermeable to cerumen, or earwax, and also to water. The balloon 6 is preferably formed of silicone or latex, or any of the known flexible materials that are used for otoplastics and other cavity-insertible products known, especially, in the hearing aid arts. It may further be covered on the laterally outside walls, i.e., the walls that are braced into contact with the walls of the ear canal 2, with a soft silicone or rubber material layer.

1. An ear piece for a hearing device, the ear piece comprising:
a receiver module housing a control unit for generating audible sound to be delivered to the tympanic membrane bounding an external auditory canal;
an inflatable balloon attached to said receiver module, said inflatable balloon having a shape and a size to brace against the walls of the auditory canal upon being inflated and to allow easy removal of the ear piece from the auditory canal when said balloon is deflated; and
a pressure relief valve pneumatically connected to an interior of said balloon and selectively activatable for deflating said balloon.

2. The ear piece according to claim 1, wherein the ear piece has a size and a shape enabling deep insertion into the external auditory canal and in close vicinity of the tympanic membrane.

3. The ear piece according to claim 1, wherein said control unit comprises a connection to an external device providing signals for said control unit.

4. The ear piece according to claim 1, wherein said pressure relief valve is integrally formed together with said receiver module.

5. The ear piece according to claim 1, wherein said pressure relief valve includes a piston and a spring means biasing said piston against a valve seat for closing a pneumatic connection from an interior of said balloon to an exterior.

6. The ear piece according to claim 5, wherein said pressure relief valve includes a pull string connected to said piston for pulling said piston backward against a spring force of said spring means and for relieving a pressure in and deflating said balloon.

7. The ear piece according to claim 3, wherein said signal connection includes an electrical cable carrying electrical control signals and an energy supply.

8. The ear piece according to claim 1, which comprises a tube pneumatically connecting said balloon with an exterior pump for selectively inflating said balloon.

9. The ear piece according to claim 1, which comprises a pump disposed in said receiver module for selectively inflating said balloon, and a pneumatic connection enabling aspiration of air through the auditory canal for inflation of said balloon.

10. The ear piece according to claim 1, which comprises a carrier member mounted to said receiver module and said balloon, for attaching and sealing said balloon against said receiver module.

11. The ear piece according to claim 10, wherein said carrier member is funnel-shaped with a central bore for guiding sound waves generated by said control unit in said receiver module through a forward wall of the ear piece and to the tympanic membrane.

12. The ear piece according to claim 1 for use in combination with a hearing aid.

13. A hearing device, comprising:
an ear piece according to claim 1; and
an external unit for transmitting to said ear piece signals for generating sound to be perceived by the tympanic membrane.

14. The hearing device according to claim 13 formed as a hearing aid, wherein the external unit is a hearing unit selected from the group consisting of behind-the-ear (BTE) , in-the-ear (ITE), concha, in-the-canal (ITC), and completely-in-the-canal (CIC) hearing unit.

15. The hearing device according to claim 14, wherein the hearing aid is a CIC hearing aid and said external unit and said ear piece are integrally connected to one another.

16. The hearing device according to claim 13, wherein the external unit is a sound player or a telephone.
